(19) United States
(12) Patent Application Publication
(10) Pub. No.: US 2013/0112665 A1
(43) Pub. Date: May 9, 2013

(54) DEVICE AND METHOD OF VIBRO-SPOT WELDING

(71) Applicant: In Tai Jin, Busan (KR)

(72) Inventor: In Tai Jin, Busan (KR)

(73) Assignees: Pukyong National University Business Incubator Cen, Busan (KR); Sungwoo Hitech Co., Ltd., Busan (KR)

(21) Appl. No.: 13/806,194

(22) PCT Filed: Jul. 21, 2011
(86) PCT No.: PCT/KR2011/005382

§ 371 Date: Dec. 21, 2012

(30) Foreign Application Priority Data
Jul. 26, 2010 (KR) 10-2010-0071877
Jul. 21, 2011 (KR) 10-2011-0072362

(51) Int. Cl. B23K 11/00; B23K 20/10

(52) U.S. Cl. CPC B23K 11/00; B23K 20/10
USPC 219/78.01; 228/1.1

(57) ABSTRACT

A device and a method of vibro-spot welding which weld overlapped metal plates by heating welding portions of the overlapped metal plates and applying linear and repetitive load to the welding portions are disclosed. The device of vibro-spot welding may include a pair of vibration welders facing each other with respect to overlapped metal plates, wherein at least one of the pair of vibration welders heats welding portions of the metal plates, generates plastic flow at the welding portions by moving the welding portions reciprocally between the pair of vibration welders, and joining the welding portions by applying pressure to the welding portions at which the plastic flow occurs.

In addition, the method of vibro-spot welding may include: applying pressure to a pair of electrodes facing each other with respect to overlapped metal plates such that the metal plates are tightly contacted with each other; heating welding portions of the metal plates by supplying power to the pair of electrodes; generating plastic flow at the welding portions by reciprocally moving the heated welding portions; and welding the overlapped metal plates by pressing the welding portions at which the plastic flow occurs.

### TECHNICAL FIELD

The present invention relates to a device and a method of vibro-spot welding. More particularly, the present invention relates to a device and a method of vibro-spot welding which weld overlapped metal plates by heating welding portions of the overlapped metal plates and applying linear and repetitive load to the welding portions.

### BACKGROUND

Generally, methods of welding comparatively thin two overlapped metal plates include fusion welding and solid phase welding. Spot welding which is fusion welding means welding method in which heat due to electrical resistance and pressure are applied to welding portions of the overlapped metal plates such that the welding portions are melted and welded. Friction stir welding (FSW) which is solid phase welding means welding method in which a probe of a rotating tool is inserted into the overlapped metal plate. In this case, the metal plates around the tool are softened by frictional heat between the rotating probe and the metal plates and the welding portions of both metal plates are forcibly mixed by plastic flow occurring at the welding portions due to stir of the tool. Therefore, the metal plates are welded.

Each of the spot welding and friction stir welding has merits and drawbacks.

For example, since the welding portions of the metal plates are melted and welded by heat generated by the electrical resistance according to the spot welding metal plate, an electric arc occurs at contacting surfaces due to apply of high current and welding surface defects may occur.

Since the friction stir welding is the solid phase welding, mechanical strength of the welded metal plates is excellent and the electric arc does not occur. Therefore, the friction stir welding is suitable for light metal plates. However, welding indentation or hole due to rotation of the probe may remain at the welding surface after welding.

In order to solve such problems of the spot welding and the friction stir welding, an extru-spot welding method (ESW) disclosed in Korean Patent No. 743857 has been developed. It is disclosed in Korean Patent No. 743857 that the overlapped two metal plates and a separate metal band are heated by an electrode in a moment, an extrusion material is punched from the metal band, and the punched extrusion material are extruded into the overlapped metal plates such that the metal plates are welded. Such an extru-spot welding method has merits of strong bonding force and non-occurrence of arc but has drawbacks of using the separate metal band.

### CONTENTS OF THE INVENTION

### Technical Object

The present invention has been made in an effort to provide a device and a method of vibro-spot welding having advantages of welding overlapped metal plates by heating welding portions of the overlapped metal plates and applying linear and repetitive load to the welding portions.

### Means for Achieving the Object

A device of vibro-spot welding according to one or more exemplary embodiments of the present invention may include a pair of vibration welders facing each other with respect to overlapped metal plates, wherein at least one of the pair of vibration welders heats welding portions of the metal plates, generates plastic flow at the welding portions by moving the welding portions reciprocally between the pair of vibration welders, and joining the welding portions by applying pressure to the welding portions at which the plastic flow occurs.

The at least one of the pair of vibration welders may include: an electrode for heating the overlapped metal plates by receiving current; a cylinder mounted at a rear end portion of the electrode and receiving the pressure for reciprocally moving and pressing the welding portions of the metal plates; and a vibration piston having a front end and a rear end connected to each other, wherein the rear end is positioned in the cylinder so as to receive the pressure and the front end penetrates the cylinder and the electrode so as to reciprocally move or press the welding portions of the metal plates.

The vibration welder may further include a pressing piston positioned at the rear of the vibration piston in the cylinder and pressing the welding portions of the metal plates by receiving the pressure generated in the cylinder and transmitting the pressure to the vibration piston.

A first chamber may be formed between the vibration piston and the pressing piston in the cylinder, and the first chamber may be adapted to receive the pressure for reciprocally moving the welding portions of the metal plates.

A first stopper for adjusting a reciprocating distance of the vibration piston may be mounted on an interior circumference of the cylinder at the rear of the vibration piston.

A cover may be mounted at a rear end of the cylinder, wherein a second chamber is formed between the pressing piston and the cover in the cylinder, and the second chamber is adapted to receive the pressure for pressing the welding portions at which the plastic flow occurs.

An elastic member may be positioned between the rear end of the vibration piston and a front end of the cylinder.

A second stopper may be mounted on the interior circumference of the cylinder at the rear of the pressing piston, and the second stopper may be adapted to support the pressing piston by counteracting against the pressure of the first chamber.

Each of the pair of vibration welders may include the electrode, the cylinder and the vibration piston, wherein front ends of the pair of vibration pistons have the same cross-sectional shape and are disposed to form a predetermined angle with each other with respect to a length direction of the vibration piston.

In one or more exemplary embodiments, the front ends of the pair of vibration pistons may have triangular cross-sectional shape and may be disposed to form 180° with each other with respect to the length direction of the vibration piston.

In one or more exemplary embodiments, the front ends of the pair of vibration pistons may have quadrangular cross-sectional shape and may be disposed to form 45° with each other with respect to the length direction of the vibration piston.

A device of vibro-spot welding according to another exemplary embodiment of the present invention may include a pair of vibration welders facing each other with respect to overlapped metal plates, wherein at least one of the pair of vibration welders includes an electrode for heating the overlapped metal plates by receiving current; a cylinder mounted at a rear end portion of the electrode; a cover coupled to a rear end of the cylinder; a vibration piston having a front end and a rear end connected to each other, wherein the rear end is positioned in the cylinder and the front end penetrates the cylinder and the electrode and contacts with one of the overlapped metal plates; a pressing piston positioned at the rear of the vibration piston in the cylinder; a first chamber formed between the vibration piston and the pressing piston in the cylinder and adapted to apply pressure for reciprocally moving welding portions of the metal plates to the vibration piston; and a second chamber formed between the pressing piston and the cover in the cylinder and adapted to apply pressure for pressing the welding portions at which plastic flow occurs to the pressing piston.

An elastic member may be positioned between the rear end of the vibration piston and a front end of the cylinder.

A first stopper for adjusting a reciprocating distance of the vibration piston may be mounted on an interior circumference of the cylinder at the rear of the vibration piston.

A second stopper for supporting the pressing piston by counteracting against the pressure of the first chamber may be mounted on the interior circumference of the cylinder at the rear of the pressing piston.

Each of the pair of vibration welders may include the electrode, the cylinder and the vibration piston, wherein front ends of the pair of vibration pistons have the same cross-sectional shape and are disposed to form a predetermined angle with each other with respect to a length direction of the vibration piston.

In one or more exemplary embodiments, the front ends of the pair of vibration pistons may have triangular cross-sectional shape and may be disposed to form 180° with each other with respect to the length direction of the vibration piston.

In one or more exemplary embodiments, the front ends of the pair of vibration pistons may have quadrangular cross-sectional shape and may be disposed to form 45° with each other with respect to the length direction of the vibration piston.

A method of vibro-spot welding according to other exemplary embodiment of the present invention may include: applying pressure to a pair of electrodes facing each other with respect to overlapped metal plates such that the metal plates are tightly contacted with each other; heating welding portions of the metal plates by supplying power to the pair of electrodes; generating plastic flow at the welding portions by reciprocally moving the heated welding portions; and welding the overlapped metal plates by pressing the welding portions at which the plastic flow occurs.

In one or more exemplary embodiments, the welding portions of the overlapped metal plates may have triangular cross-sectional shape and may be disposed to form 180° with each other.

In one or more exemplary embodiments, the welding portions of the overlapped metal plates may have quadrangular cross-sectional shape and may be disposed to form 45° with each other.

### Effect of the Invention

As described above, the welding portions are heated by the electrodes and repetitive load is applied to the welding portions such that the plastic flow occurs. After that, the welding portions are pressed and the overlapped metal plates are welded. Therefore, electric arc may not occur.

In addition, since the plastic flow is generated at the welding portions by relatively small repetitive load, energy consumption may be small.

Furthermore, light metals that are hard to be welded due to the electric arc may be welded.

### BRIEF DESCRIPTION OF THE DRAWINGS

FIG. 1 is a cross-sectional view of a device of vibro-spot welding according to an exemplary embodiment of the present invention.

FIG. 2 is a perspective view of a vibration welder according to an exemplary embodiment of the present invention.

FIG. 3 is a perspective view of a vibration piston according to an exemplary embodiment of the present invention.

FIG. 4 is a cross-sectional view for showing processes of vibrating welding portions of two metal plates using a device of vibro-spot welding according to an exemplary embodiment of the present invention.

FIG. 5 is a schematic diagram of an example of welding portions in a case that a device of vibro-spot welding according to an exemplary embodiment of the present invention is used.

FIG. 6 is a schematic diagram of another example of welding portions in a case that a device of vibro-spot welding according to an exemplary embodiment of the present invention is used.

FIG. 7 is a schematic diagram of a device of vibro-spot welding according to an exemplary embodiment of the present invention mounted at a robot.

FIG. 8 is a flowchart of a method of vibro-spot welding according to an exemplary embodiment of the present invention.

### BEST MODE FOR EXECUTING THE INVENTION

An exemplary embodiment of the present invention will hereinafter be described in detail with reference to the accompanying drawings.

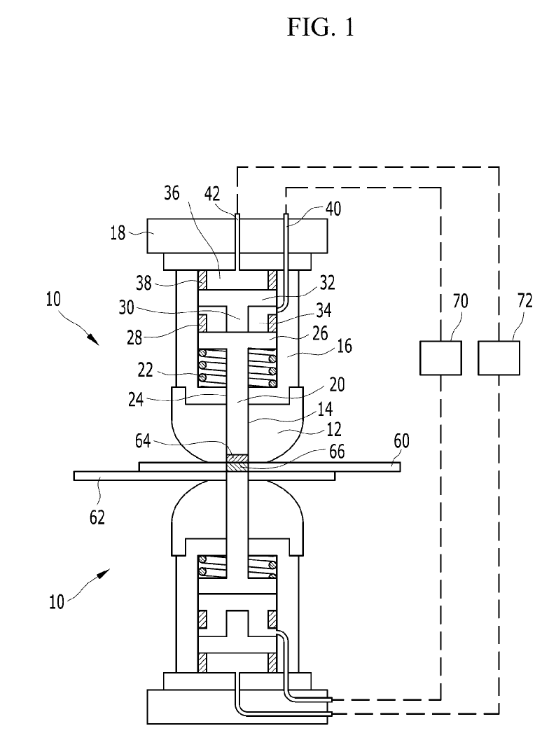

As shown in FIG. 1, a device of vibro-spot welding according to an exemplary embodiment of the present invention includes a pair of vibration welders 10 facing with each other with respect to overlapped first and second metal plates 60 and 62. The pair of vibration welders 10 may have the same structure or not. For ease of description, it is exemplified in this specification, but is not limited to that the pair of vibration welders 10 has the same structure.

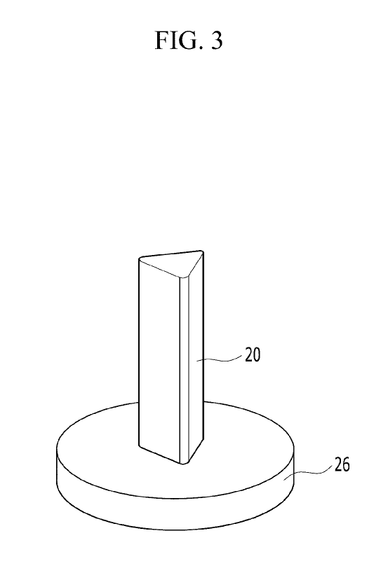

As shown in FIG. 1 to FIG. 3, the vibration welders 10 heat welding portions 64 and 66 of the metal plates 60 and 62, generate plastic flow by reciprocally moving the welding portions 64 and 66, and weld the welding portions 64 and 66 at which the plastic flow occurs. For achieving such functions, each of the vibration welders 10 includes an electrode 12, a cylinder 16, a vibration piston 20, a pressing piston 30 and a cover 18. The electrode 12 is mounted at a front end of the cylinder 16, the vibration piston 20 and the pressing piston 30 are mounted in the cylinder 16, and the cover 18 is mounted at a rear end of the cylinder 18.

Herein, a front side or a front end means a side or an end close to the metal plates 60 and 62, and a rear side or a rear end means a side or an end far from the metal plates 60 and 62.

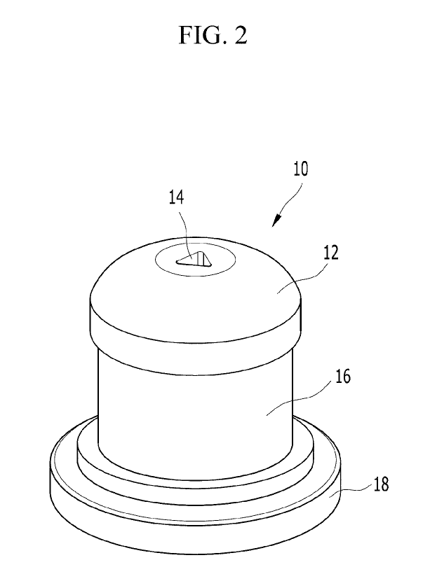

The electrode 12 contacts with each of the metal plates 60 and 62 and causes the metal plates 60 and 62 to be tightly contacted with each other. Since electrical resistance of contacting portion of the electrode 12 and each of the metal plates 60 and 62 is high, the metal plates 60 and 62 are heated by the electrical resistance if high current is applied to the electrode 12. Therefore, the electrode 12 heats the welding portions 64 and 66 of the metal plates 60 and 62 in a moment. In one or more exemplary embodiments, the electrode 12 has a cylindrical shape, a diameter of which becomes smaller toward the front, so as to heat special portions (e.g., the welding portions 64 and 66) of the metal plates 60 and 62. However, the shape of the electrode 12 is not limited to the cylindrical shape. In addition, a guide hole 14 is formed from the rear side to the front side of the electrode 12. In FIG. 2, a cross-sectional shape of the guide hole 14 is a triangle, but is not limited to this.

The cylinder 16 is coupled to the rear end of the electrode 12. The cylinder 16 has a hollow cylindrical shape, but is not limited to this. A penetration hole 24 corresponding to the guide hole 14 of the electrode 12 is formed at a front surface of the cylinder 16. The rear end of the cylinder 16 is blocked by the cover 18.

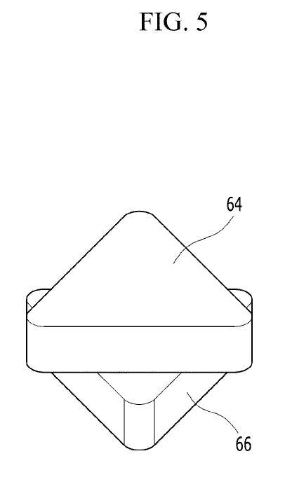

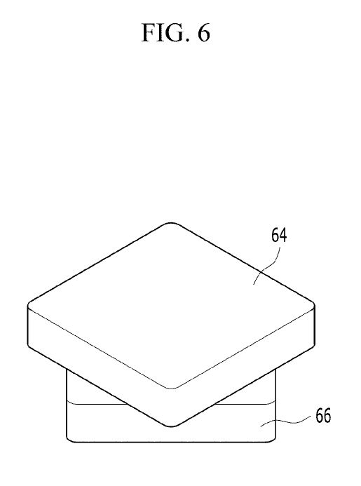

The vibration piston 20 is mounted in the cylinder 16. A front end of the vibration piston 20 penetrates through the penetration hole 24 and the guide hole 14 and contacts with each of the welding portions 64 and 66 of the metal plates 60 and 62. Therefore, a cross-sectional shape of the front end of the vibration piston 20 is very similar to those of the penetration hole 24 and the guide hole 14. For example, in a case that the welding portions 64 and 66 have triangular shape, the cross-sectional shape of the front end of the vibration piston 20 is triangle, as shown in FIG. 5. On the contrary, in a case that the welding portions 64 and 66 have quadrangular shape, the cross-sectional shape of the front end of the vibration piston 20 is quadrangle, as shown in FIG. 6.

In addition, the front ends of the pair of vibration pistons 20 form a predetermined angle with each other such that the first and second welding portions 64 and 66 at which the plastic flow occurs are mixed with each other. For example, in the case that the first and second welding portions 64 and 66 have the triangular cross-sectional shape as shown in FIG. 5, the first and second welding portions 64 and 66 form 180° with each other. Therefore, predetermined portions (that is, center portions) of the first and second welding portions 64 and 66 can move together with the vibration pistons 20 between a pair of guide holes 14, and the other portions (that is, peripheral portions) of the first and second welding portions 64 and 66 can move only to the front ends of the electrodes 12 and are not pushed into the guide holes 14. Similarly, in the case that the first and second welding portions 64 and 66 have the quadrangular cross-sectional shape as shown in FIG. 6, the first and second welding portions 64 and 66 form 45° with each other.

Reciprocal motion of the vibration piston 20 is caused by pressure supplied to a first chamber 34. The first chamber 34 is formed between the vibration piston 20 and the pressing piston 30 in the cylinder 16. Therefore, a rear end 22 of the vibration piston and a rear end 32 of the pressing piston are tightly contacted with an interior circumference of the cylinder 16. In addition, sealing members (e.g., O-ring) may be mounted respectively between the rear end 22 of the vibration piston and the interior circumference of the cylinder 16 and between the rear end 32 of the pressing piston and the interior circumference of the cylinder 16. In addition, the first chamber 34 is connected to a first pressure supply portion 70 through a first line 40 so as to receive the pressure. The pressure may be hydraulic pressure or pneumatic pressure. In addition, the pressure is supplied to a pair of the first chambers 34 by turns or simultaneously.

A first stopper 28 is mounted on the interior circumference of the cylinder 16 in the first chamber 34. The first stopper 28 limits a moving distance of the vibration piston 20. That is, if one vibration piston 20 is moved by the pressure of one first chamber 34, the other vibration piston 20 connected thereto through the vibration piston 20 and the welding portions 64 and 66 is also moved. At this time, the other vibration piston 20 is not moved more than a predetermined distance by the first stopper 28. In addition, the first stopper 28 may be movably coupled to the interior circumference of the cylinder 16. Screw-coupling may be used as the movable coupling. Therefore, the moving distance of the vibration piston 20 can be adjusted by adjusting a position of the first stopper 28 in the cylinder 16.

An elastic member 22 is mounted between the rear end 22 of the vibration piston and the front end of the cylinder 16. The elastic member 22 exerts elastic force counteracting against the pressure of the first chamber 34 on the vibration piston 20.

The pressing piston 30 is disposed at the rear of the vibration piston 20 in the cylinder 16. The pressing piston 30 presses and welds the welding portions 64 and 66 at which the plastic flow occurs by the vibration piston 20. The pressing piston 30 presses the welding portions 64 and 66 by pressure supplied to a second chamber 36. That is, if the pressure is supplied to the second chamber 36, the pressure pushes the rear end 32 of the pressing piston toward the welding portions 64 and 66, and the pressing piston 30 pushes the rear end of the vibration piston 20 toward the welding portions 64 and 66 and presses the welding portions 64 and 66. The pressure is simultaneously supplied to a pair of the second chambers 36. In this case, the pressure is applied to the welding portions 64 and 66 from both opposite directions, and the welding portions 64 and 66 are welded with each other.

The second chamber 36 is connected to a second pressure supply portion 72 through a second line 42 so as to receive the pressure. The first pressure supply portion 70 and the second pressure supply portion 72 may be integrally formed with each other.

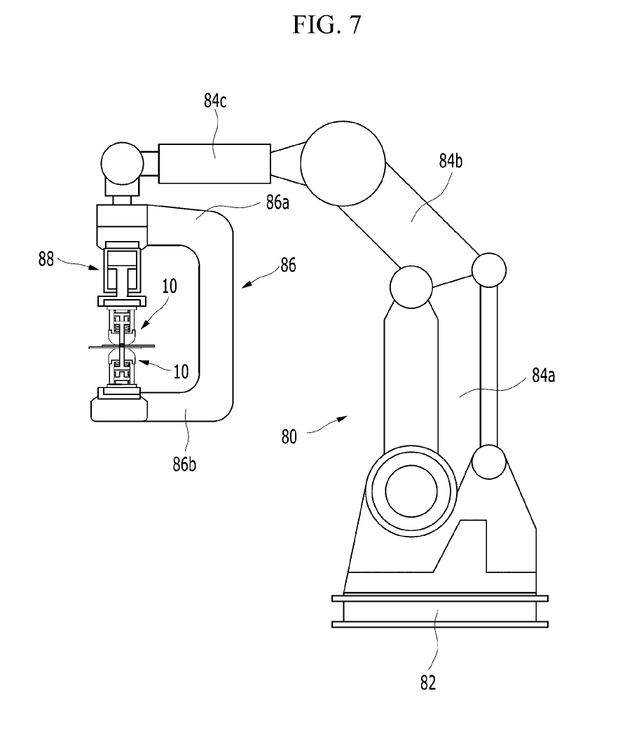

As shown in FIG. 7, the device of vibro-spot welding according to an exemplary embodiment of the present invention may be mounted at a multi-links robot 80. The multi-links robot 80 is mounted on a base 82 and includes a plurality of links 84a, 84b, and 84c. The plurality of links 84a, 84b, and 84c is rotatable relative to each other. A front end portion 86 of the robot 80 has first and second arms 86a and 86b disposed apart from each other, and the device of vibro-spot welding according to an exemplary embodiment of the present invention is mounted between the first and second arms 86a and 86b. At this time, one of the pair of vibration welders 10 is mounted through a moving cylinder 88 at any one of the first and second arms 86a and 86b so as to be movable toward the other of the pair of vibration welders 10. That is, an upper vibration welder 10 is mounted at the first arm 86a through the moving cylinder 88 and a lower vibration welder 10 is directly mounted at the second arm 86b, as shown in FIG. 7.

The moving cylinder 88 applies pressure to the vibration welder 10 such that the overlapped metal plates 60 and 62 are tightly contacted with each other.

Hereinafter, a method of vibro-spot welding according to an exemplary embodiment of the present invention will be described in detail.

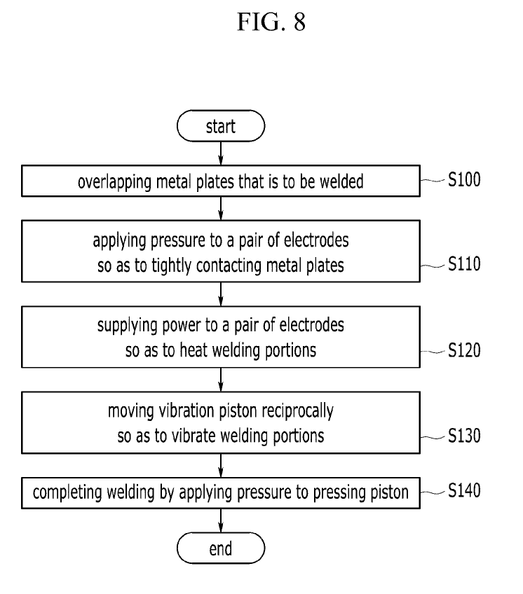

The method of vibro-spot welding according to an exemplary embodiment of the present invention, as shown in FIG. 8, begins by overlapping the metal plates 60 and 62 that are to be welded at step S100.

If the metal plates 60 and 62 are overlapped, the metal plates 60 and 62 are positioned between the pair of vibration welders 10. After that, the pressure is applied to the pair of electrodes 12 by the moving cylinder 88 and the overlapped metal plates 60 and 62 are tightly contacted with each other at step S110.

If the overlapped metal plates 60 and 62 are tightly contacted, power is supplied to the pair of electrodes 12 so as to heat the welding portions 64 and 66 rapidly at step S120. If the welding portions 64 and 66 are heated, the welding portions 64 and 66 are softened.

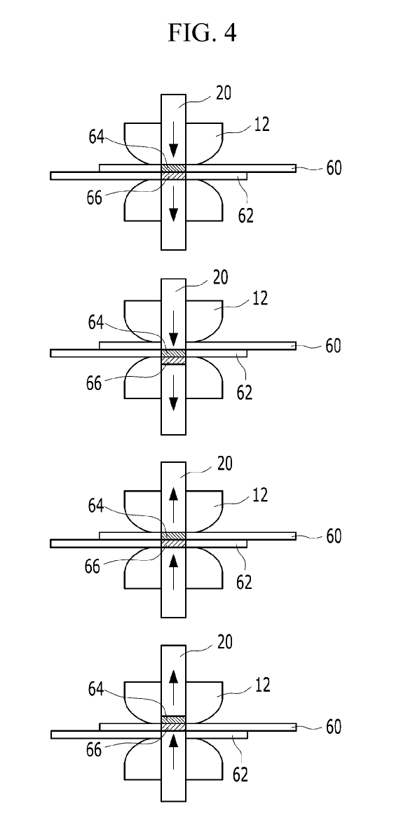

After that, the pressure is applied to the pair of vibration pistons 20 alternately so as to move the heated welding portions 64 and 66 reciprocally at step S130. As shown in FIG. 4, if the pressure is applied downwardly to the upper vibration piston 20, the first welding portion 64 moves to the same plane as the second metal plate 62 and the second welding portion 66 is inserted in the guide hole 14 of a lower electrode 12. If the pressure applied to the upper vibration piston 20 is removed at this state, the first and second welding portions 64 and 66 are returned to their original positions by the elastic force of the elastic member 22 and the pressure of the lower vibration piston 20. If the pressure is applied to the lower vibration piston 20 at this state, the second welding portion 66 moves to the same plane as the first metal plate 60 and the first welding portion 64 is inserted in the guide hole 14 of an upper electrode 12.

If above-mentioned processes are repeated, the plastic flow occurs at the first and second welding portions 64 and 66, and the first and second welding portions 64 and 66 are mixed with each other.

If the first and second welding portions 64 and 66 at which the plastic flow occurs are sufficiently mixed with each other, the pressure is simultaneously applied to the pair of pressing pistons 30 such that the first and second welding portions 64 and 66 are pressed at step S140. Therefore, welding of the first and second welding portions 64 and 66 is completed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A device of vibro-spot welding comprising a pair of vibration welders facing each other with respect to overlapped metal plates,
wherein at least one of the pair of vibration welders heats welding portions of the metal plates, generates plastic flow at the welding portions by moving the welding portions reciprocally between the pair of vibration welders, and joining the welding portions by applying pressure to the welding portions at which the plastic flow occurs.

2. The device of claim 1, wherein the at least one of the pair of vibration welders comprises:
an electrode for heating the overlapped metal plates by receiving current;
a cylinder mounted at a rear end portion of the electrode and receiving the pressure for reciprocally moving and pressing the welding portions of the metal plates; and
a vibration piston having a front end and a rear end connected to each other, wherein the rear end is positioned in the cylinder so as to receive the pressure and the front end penetrates the cylinder and the electrode so as to reciprocally move or press the welding portions of the metal plates.

3. The device of claim 2, further comprising a pressing piston positioned at the rear of the vibration piston in the cylinder and pressing the welding portions of the metal plates by receiving the pressure generated in the cylinder and transmitting the pressure to the vibration piston.

4. The device of claim 3, wherein a first chamber is formed between the vibration piston and the pressing piston in the cylinder, and the first chamber is adapted to receive the pressure for reciprocally moving the welding portions of the metal plates.

5. The device of claim 3, wherein a first stopper for adjusting a reciprocating distance of the vibration piston is mounted on an interior circumference of the cylinder at the rear of the vibration piston.

6. The device of claim 3, wherein a cover is mounted at a rear end of the cylinder, and
wherein a second chamber is formed between the pressing piston and the cover in the cylinder, and the second chamber is adapted to receive the pressure for pressing the welding portions at which the plastic flow occurs.

7. The device of claim 3, wherein an elastic member is positioned between the rear end of the vibration piston and a front end of the cylinder.

8. The device of claim 4, wherein a second stopper is mounted on the interior circumference of the cylinder at the rear of the pressing piston, and the second stopper is adapted to support the pressing piston by counteracting against the pressure of the first chamber.

9. The device of claim 2, wherein each of the pair of vibration welders comprises the electrode, the cylinder and the vibration piston, and
wherein front ends of the pair of vibration pistons have the same cross-sectional shape and are disposed to form a predetermined angle with each other with respect to a length direction of the vibration piston.

10. The device of claim 9, wherein the front ends of the pair of vibration pistons have triangular cross-sectional shape and are disposed to form 180° with each other with respect to the length direction of the vibration piston.

11. The device of claim 9, wherein the front ends of the pair of vibration pistons have quadrangular cross-sectional shape and are disposed to form 45° with each other with respect to the length direction of the vibration piston.

12. A device of vibro-spot welding comprising a pair of vibration welders facing each other with respect to overlapped metal plates,
wherein at least one of the pair of vibration welders comprises
an electrode for heating the overlapped metal plates by receiving current;
a cylinder mounted at a rear end portion of the electrode;
a cover coupled to a rear end of the cylinder;
a vibration piston having a front end and a rear end connected to each other, wherein the rear end is positioned in the cylinder and the front end penetrates the cylinder and the electrode and contacts with one of the overlapped metal plates;
a pressing piston positioned at the rear of the vibration piston in the cylinder;
a first chamber formed between the vibration piston and the pressing piston in the cylinder and adapted to apply pressure for reciprocally moving welding portions of the metal plates to the vibration piston; and
a second chamber formed between the pressing piston and the cover in the cylinder and adapted to apply pressure for pressing the welding portions at which plastic flow occurs to the pressing piston.

13. The device of claim 12, wherein an elastic member is positioned between the rear end of the vibration piston and a front end of the cylinder.

14. The device of claim 12, wherein a first stopper for adjusting a reciprocating distance of the vibration piston is mounted on an interior circumference of the cylinder at the rear of the vibration piston.

15. The device of claim 12, wherein a second stopper for supporting the pressing piston by counteracting against the pressure of the first chamber is mounted on the interior circumference of the cylinder at the rear of the pressing piston.

16. The device of claim 12, wherein each of the pair of vibration welders comprises the electrode, the cylinder and the vibration piston, and
wherein front ends of the pair of vibration pistons have the same cross-sectional shape and are disposed to form a predetermined angle with each other with respect to a length direction of the vibration piston.

17. The device of claim 16, wherein the front ends of the pair of vibration pistons have triangular cross-sectional shape and are disposed to form 180° with each other with respect to the length direction of the vibration piston.

18. The device of claim 16, wherein the front ends of the pair of vibration pistons have quadrangular cross-sectional shape and are disposed to form 45° with each other with respect to the length direction of the vibration piston.

19. A method of vibro-spot welding, comprising:
applying pressure to a pair of electrodes facing each other with respect to overlapped metal plates such that the metal plates are tightly contacted with each other;
heating welding portions of the metal plates by supplying power to the pair of electrodes;
generating plastic flow at the welding portions by reciprocally moving the heated welding portions; and
welding the overlapped metal plates by pressing the welding portions at which the plastic flow occurs.

20. The method of claim 19, wherein the welding portions of the overlapped metal plates have triangular cross-sectional shape and are disposed to form 180° with each other.

21. The method of claim 19, wherein the welding portions of the overlapped metal plates have quadrangular cross-sectional shape and are disposed to form 45° with each other.
